(19) United States
(12) Patent Application Publication
(10) Pub. No.: US 2015/0082792 A1
(43) Pub. Date: Mar. 26, 2015

(54) SOLAR AND RENEWABLE/WASTE ENERGY POWERED TURBINE WITH TWO STAGE HEATING AND GRAPHITE BODY HEAT EXCHANGER

(71) Applicant: GRAPHITE ENERGY N.V., Amersterdam (NL)

(72) Inventors: Nicholas Jordan Bain, Sydney (AU); Paul Soo-Hock Khoo, Sydney (AU); David John Reynolds, Sydney (AU)

(21) Appl. No.: 14/381,762

(22) PCT Filed: Mar. 7, 2013
(86) PCT No.: PCT/AU2013/000223

§ 371 Date: Aug. 28, 2014

(30) Foreign Application Priority Data
Mar. 8, 2012 (AU) 2012900930
May 7, 2012 (AU) 2012901857

(51) Int. Cl. F03G 6/06; F01K 11/02

(52) U.S. Cl. CPC F03G 6/065; F01K 11/02
USPC 60/641.15; 60/645

(57) ABSTRACT

A turbine driven from renewable or waste energy sources has a working fluid in a two stage heating process using a first heating apparatus using a renewable or waste energy source and a second heating apparatus comprising a graphite body containing an embedded heat exchanger heated by concentrated solar energy where the graphite body releases stored heat to heat the working fluid to provide a continuous stream of the working fluid heated to a working temperature for input to the turbine. A relationship exists between an outer surface area of the embedded heat exchanger tube and a mass of graphite in the graphite body whereby there is from 0.60 m² to 20 m² of outer surface area of embedded heat exchanger tube per tonne of graphite in the graphite body.

### TECHNICAL FIELD

This invention concerns a process for generating electricity using a turbine driven from renewable and/or waste energy sources.

### BACKGROUND

The generation of super heated steam for steam turbines typically involves two phases: feed water pre-heat/evaporation and superheating.

Evaporation involves heating water under pressure to generate saturated steam. The temperature of saturated steam varies with pressure. For example, for a pressure of 1 barG, saturation temperature is 120° C., and at a pressure of 100 barG, saturation temperature is 312° C. Thereafter, the saturated steam is superheated to a temperature of up to, say, 500° C. to enable the use of higher thermal efficiency steam turbine generators.

The concentrated solar power (CSP) industry has struggled to generate consistent high temperature superheated steam. This is because they use a single pass through a solar heat exchanger to convert cold water to super heated steam. Problems arise after evaporation when the heat exchanger is filled with steam, a vapor rather than liquid, dramatically reducing the ability to transfer heat through the heat exchanger tube to the fluid within. The heat transfer rate between the walls of the heat exchanger tube to steam is very much less than that of heat exchanger tube to water. Compounding this, the solar flux is directed to only one side of the heat exchanger pipe. Consequently the risk of overheating the heat exchanger tubes by solar radiation energy (insolation) is increased and the difficulty of managing the heat exchanger tube temperature is magnified.

Traditionally the CSP industry attempts to manage superheating of steam from insolation using two techniques:

Control of the solar reflector (which may include dumping the available solar energy by not using parts of the solar field); or

By using intermediate heat transfer fluids such as molten salt, which adds complexity and losses in efficiency as additional heat exchange processes are required to convert heat from this fluid to steam. The maximum operating temperature of the intermediate heat transfer fluid may need to be constrained to prevent vaporization of the said fluid.

### DISCLOSURE OF THE INVENTION

In a first aspect the invention provides a process for operating a turbine driven from renewable or waste energy sources wherein a working fluid which drives the turbine is passed around a working fluid circuit and heated in a two stage heating process using a first heating apparatus using a renewable or waste energy source and a second heating apparatus comprising a graphite body heated by concentrated solar energy the graphite body containing an embedded heat exchanger comprising at least one heat exchanger tube embedded in and in contact with the graphite body, the process, comprising:
heating the working fluid using the renewable or waste energy source to generate a stream of working fluid heated to an intermediate temperature;
heating the graphite body using the concentrated solar energy to store heat within the graphite body;
delivering the stream of heated working fluid into the heat exchanger which is embedded in the graphite body whereby the graphite body releases stored heat to heat the working fluid to provide a continuous stream of the working fluid heated to a working temperature for input to the turbine; and
wherein; a relationship exists between an outer surface area of the embedded heat exchanger tube and a mass of graphite in the graphite body whereby there is from 0.60 m² to 20 m² of outer surface area of embedded heat exchanger tube per tonne of graphite.

According to a second aspect, a system is provided for heating a working fluid from renewable or waste energy sources for operating a turbine wherein a working fluid which drives the turbine is passed around a working fluid circuit and heated in a two stage heating process, the system comprising:
a first heating apparatus which uses a renewable or waste energy source to heat the working fluid; and
a second heating apparatus comprising a graphite body heated by concentrated solar energy;
the graphite body containing an embedded heat exchanger comprising at least one heat exchanger tube embedded in and in contact with the graphite body, wherein:
the first heating apparatus is arranged to produce a stream of working fluid heated to a nominal intermediate temperature;
the first heating apparatus is connected to the graphite body to deliver the stream of heated working fluid into the heat exchanger which is embedded in the graphite body and the graphite body is arranged to release stored heat to heat the working fluid to provide a continuous stream of the working fluid heated to a nominal working temperature for input to the turbine; and
a relationship exists between an outer surface area of the embedded heat exchanger tube and a mass of graphite in the graphite body whereby there is from 0.60 m² to 20 m² of outer surface area of embedded heat exchanger tube per tonne of graphite in the graphite body.

In various embodiments of the invention the relationship between the outer surface area of the embedded heat exchanger tube and the mass of graphite in the graphite body may be in the range of 0.60 m² to 2.0 m², or 1.0 m² to 4.0 m², or 2.0 m² to 5.0 m², or 2.0 m² to 2.50 m², or 2.50 m² to 5.0 m², or 4.0 m² to 6.0 m², or 5.0 m² to 8.0 m², or 6.0 m² to 10.0 m², or 8.0 m² to 12.0 m², or 10.0 m² to 14.0 m² or 12.0 m² to 16.0 m², or 14.0 m² to 18.00 m², or 16.0 m² to 20.0 m² of outer surface area of embedded heat exchanger tube per tonne of graphite in the graphite body. Operation of the heat exchanger in graphite body is particularly efficient if the relationship between the outer surface area of the embedded heat exchanger tube and the mass of graphite in the graphite body is in the range of 0.6 m² to 2.2 m², or 1.0 m² to 4.0 m², or 1.0 m² to 5.0 m², 2.0 m² to 5.0 m², or 1.2 m² to 3.0 m², or 1.2 m² to 2.2 m², or 1.5 m² to 2.5 m², or 2.0 m² to 3.0 m², or 2.0 m² to 2.50 m², or 2.50 m² to 5.0 m², depending on the mode of operation. For dual mode operation, a useful range is from 1.2 m² to 3.0 m²/tonne of graphite in the graphite body, and for operation only as a superheater a useful range is from 0.6 to 2.2 m²/tonne of graphite in the graphite body.

The process and system may employ solar concentrators having a capacity to direct concentrated solar energy to the graphite body with a peak power in the range of 20 to 2000 kilowatts (kW) per tonne of graphite at periods of peak insolation.

In various embodiments of the invention the process and system may employ solar concentrators having a capacity to direct concentrated solar energy to the graphite body with a peak power per tonne of graphite in the range of 20 kW to 80 kW, or 50 kW to 100 kW, or 80 kW to 150 kW, or 100 kW to 200 kW, or 150 kW to 250 kW, or 200 kW to 300 kW, or 250 kW to 450 kW, or 300 kW to 500 kW, or 450 kW to 600 kW, or 500 kW to 800 kW, or 600 kW to 900 kW, or 800 kW to 1200 kW, or 900 kW to 1500 kW, or 1200 kW to 1800 kW, or 1500 kW to 2000 kW, or per tonne of graphite in the graphite body.

The heat transfer medium through the embedded heat exchanger may be controlled such that when the stream of working fluid is heated to a temperature less than the intermediate temperature by the first heating apparatus due to a period of inadequate supply of the renewable or waste energy source, the continuous stream of the working fluid out of the heat exchanger embedded in the graphite body continues to be heated to the working temperature for input to the turbine.

The process according to claim 13, wherein the first heating apparatus is also heated by concentrated solar energy and the period of inadequate supply is a period of interruption to, or reduction of, insolation to the first heating apparatus. The first heating apparatus may also be heated using heat provided from a waste heat recovery origin and the period of inadequate supply may be a period of interruption to, or reduction of, availability of heat from the waste heat recovery origin to the first heating apparatus. Alternatively, the first heating apparatus may be heated by heat provided from a geothermal origin and the period of inadequate supply may be a period of interruption to, or reduction of, heat provided from a geothermal origin to the first heating apparatus.

During periods of peak insolation, when the concentrated solar energy being delivered to the graphite body is greater than a level of energy required to heat the working fluid to the working temperature, the graphite body may absorb and store any additional energy for use later whereby energy dumping is minimized or eliminated and the graphite body regulates heat transfer to the heat exchanger tube to avoid overheating of the heat exchanger tube without regard to the level of insolation.

Also during an interruption to, or reduction of, insolation when the concentrated solar energy being delivered to the graphite body is less than a level of energy required to heat the working fluid to the working temperature, thermal energy stored in the graphite body, due to previous heating by the concentrated solar energy, may be drawn on to sustain the heating of the working fluid to the working temperature.

After an interruption to, or reduction of, insolation when the concentrated solar energy being delivered to the graphite body is less than a level of energy required to heat the working fluid to the working temperature for a period of time results in a reduction of the thermal energy stored in the graphite body to a level which ceases to be adequate for heating the working fluid to the working temperature, residual thermal energy in the graphite body may be used to heat the working fluid to a maintenance temperature and circulated to maintain conditions within the working fluid circuit.

The working fluid may be water/steam and the water/steam may be under sufficient pressure so that when it is heated in the heat exchanger embedded in the graphite body it becomes supercritical.

The working fluid at the intermediate temperature from the first heating apparatus may be saturated steam and when the working fluid is heated to a temperature less than the intermediate temperature it may be hot water.

The working fluid may also be carbon dioxide which when at the working temperature is supercritical.

In a third aspect the present invention provides a process for superheating steam, comprising:
heating water from either solar sources or non-solar sources (but not involving a device using graphite) under pressure to raise its temperature and create saturated steam (Evaporator Device);
passing the saturated steam into a heat exchanger tube which is embedded in a graphite body having predetermined heat transfer characteristics;

Heating the graphite body using solar radiation energy (insolation),
wherein, the graphite body provides thermal mass that absorbs and stores the solar energy as heat and controls the transfer of this heat to the heat exchanger tube uniformly around the whole diameter of the tube according to its predetermined heat transfer characteristics.

Embodiments of the present process may ensure consistent delivery of high temperature superheated steam generated from insolation and manages the risk of damage to heat exchanger tubes by using graphite as a medium to intermediate the high solar heat flux and the heat exchanger tubes (Superheater Device) as well as provide thermal storage. In this way the potential for damage to the heat exchanger tubes due to overheating from peak solar flux may be eliminated.

The heat transfer rate between a graphite body heated by solar flux and a heat exchanger tube is controlled to be lower than the heat transfer rate if a heat exchanger tube were directly heated by solar heat flux without graphite intermediation. This is because embedding the tube in the graphite ensures that the temperature on the outer wall of the heat exchanger tube is lower than it would be if the tube were directly heated.

Embodiments of the proposed process incorporate the relationship between the amount of graphite mass and the surface area of heat exchanger as this relationship affects both the rate at which the solar heat flux is transferred to the heat exchanger tube; and the amount of thermal storage. The range of heat exchanger surface area to graphite mass best suited to the Superheater Device is from 0.60 m² to 20 m² of surface area of heat exchanger tube per tonne of graphite in the graphite body. This range ensures that under all levels of concentration of solar heat flux that could be directed at the Superheater Device (which can vary depending on the time of day, season and concentration ratio applied by the solar mirror or heliostat field) the heat exchanger tube will always be able to superheat steam without risk of over temperature damage to the heat exchanger tube. If the Superheater Device is designed to perform mainly a superheater role, then the surface area of heat exchanger tube per tonne of graphite will be closer to 20 m². If the Superheater Device is designed to perform mainly a storage role, then the surface area of heat exchanger tube per tonne of graphite will be closer to 0.60 m².

The relationship between the solar energy concentrated on the graphite mass and the mass of graphite in the graphite body affects the rate of heat transfer into the graphite body by insolation and thus affects the total heat accumulated for storage or extraction by the heat exchanger. The level of solar energy concentrated on the graphite body, may be in the range of 20 to 2000 kW per tonne of graphite. This range can allow the Superheater Device to be designed to balance solar energy between direct superheating of steam and thermal storage for later use. If the Superheater Device is designed to perform mainly at a low extraction rate with no little or heat storage, then the solar energy concentrated per tonne of graphite will preferably be closer to a lower limit. If the Superheater Device is designed to perform mainly at a high extraction rate with a high level of heat storage, then the solar energy concentrated per tonne of graphite will be closer to a higher limit. The described embodiment enables a method of seamlessly transitioning the Superheater Device from functioning as a solar superheater to a solar once-through boiler when insolation is interrupted, such as caused by cloud cover, then back to a superheater when the cloud cover passes.

When the Superheater Device is functioning as a superheater, it may receive from the Evaporator Device low temperature saturated steam. When it is acting as a once-through boiler it may receive hot water.

The evaporation, that heats water to generate saturated steam prior to superheating, may be performed using any suitable non-graphite based apparatus either solar or non-solar powered.

Preferred embodiments provide a method of using the graphite to absorb and store peak solar fluxes so that energy dumping is minimized or eliminated. This occurs when the heat transfer rate from the high solar flux is greater than the heat transfer rate of the fluid within the heat exchanger tube. Thus the heat transfer rate differential is absorbed within the graphite and stored to minimize or eliminate energy dumping.

Preferred embodiments also provide a method of managing heat transfer to heat exchanger tubes from a solar source without regard to the level of insolation or requirement to regularly manage the solar flux from the solar mirror field as is the case with other direct steam CSP technologies.

### BRIEF DESCRIPTION OF THE DRAWINGS

An example of the invention will now be described with reference to the accompanying drawing,

FIG. 1 is a diagrammatic representation of a concentrating solar power plant according to an embodiment of the present invention;

FIG. 2 is a flow diagram of the process for producing superheated steam; and.

FIG. 3 is a chart showing the smaller relative enthalpy contribution of the Superheater Device and the Evaporator Device

### BEST MODES OF THE INVENTION

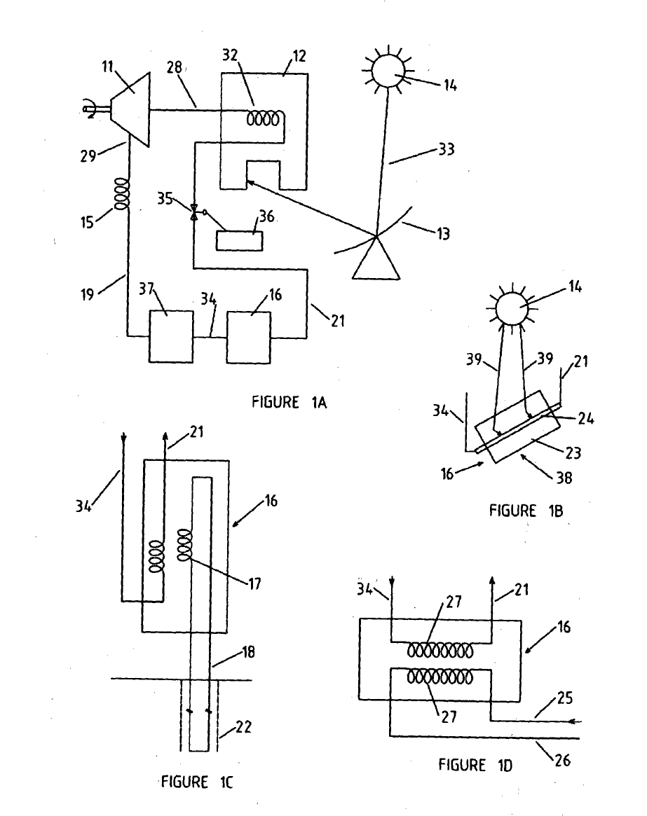

Referring to FIG. 1A, an energy conversion system comprises a turbine 11 to which a supply of heated working fluid 28 is fed from a heating system. The working fluid may be water/steam or supercritical CO₂. After passing through the turbine 11 the working fluid passes through a condenser 15 which improves the efficiency of the turbine by reducing the pressure on the outlet side 29. The condensed working fluid 19 passes into a working fluid holding tank or reservoir 37. From the reservoir 37 the working fluid is delivered through a supply pipe 34 to a first heating apparatus 16 which heats the working fluid to a nominal intermediate temperature and pressure. The working fluid at the intermediate temperature 21 is then fed from the reservoir 37, via a flow control valve 35 controlled by a controller 36 (which may additionally control other system functions) to a graphite solar receiver 12 comprising a graphite body 31 in which a heat exchanger 32 is embedded. Radiant energy 33 from the sun 14 is reflected onto the graphite body by heliostats 13 (of which one is illustrated to represent a field of heliostats). Working fluid passing through the heat exchanger 32 in the graphite body 31 is heated to the working temperature and pressure of the turbine to provide the supply of heated working fluid 28 to the turbine. A relationship exists between an outer surface area of the embedded heat exchanger tube and a mass of graphite in the graphite body whereby there is from 0.60 m² to 20 m² of outer surface area of embedded heat exchanger tube per tonne of graphite in the graphite body. In particular, for dual mode operation, where the graphite receiver is switchable between a superheating only mode and an evaporation and superheating mode, the preferred range is from 1.2 m² to 3.0 m²/tonne of graphite in the graphite body, and for operation only as a superheater the preferred range is from 0.6 m² to 2.2 m²/tonne of graphite in the graphite body.

The first heating apparatus 16 uses renewable or waste energy to heat the working fluid to the intermediate temperature. Several examples of such heating apparatus are shown diagrammatically in FIGS. 1B, 1C & 1D. In FIG. 1B, the first heating apparatus comprises a linear solar thermal receiver such as a Fresnel or trough lens based system 38. Where the working fluid is water/steam, water is passed from the condenser 15 to the receiver tube 24 in the heater and solar energy is reflected from the Fresnel or trough shaped mirror 23 to heat the water turning it into low grade steam (water vapor). In conditions of low insolation, the output 21 of the first heating apparatus may be hot water in which case the flow rate through the heat exchanger embedded in the graphite body will be controlled to allow more heating in the graphite solar receiver 12.

FIG. 1C diagrammatically illustrates a geothermal heat source 18 used to provide heat to the first heating apparatus 16. In this case the apparatus 16 comprises a heat exchanger 17 which heats the working fluid using heat extracted from a geothermal bore 22 by another working fluid pumped down the bore 22 and circulated through the heat exchanger 17. Referring to FIG. 1D, other forms of waste heat may used to heat a working fluid circulated through heat exchanger 27 from inlet 25 to outlet 26. Examples might be heat from an industrial process, heat recovered from exhaust of diesel generators, heat from a building air conditioning system or by-products of petrochemical processing, burned to heat a working fluid. The waste heat in the FIG. 1D example may also be provided by the condenser 15 seen in FIG. 1A.

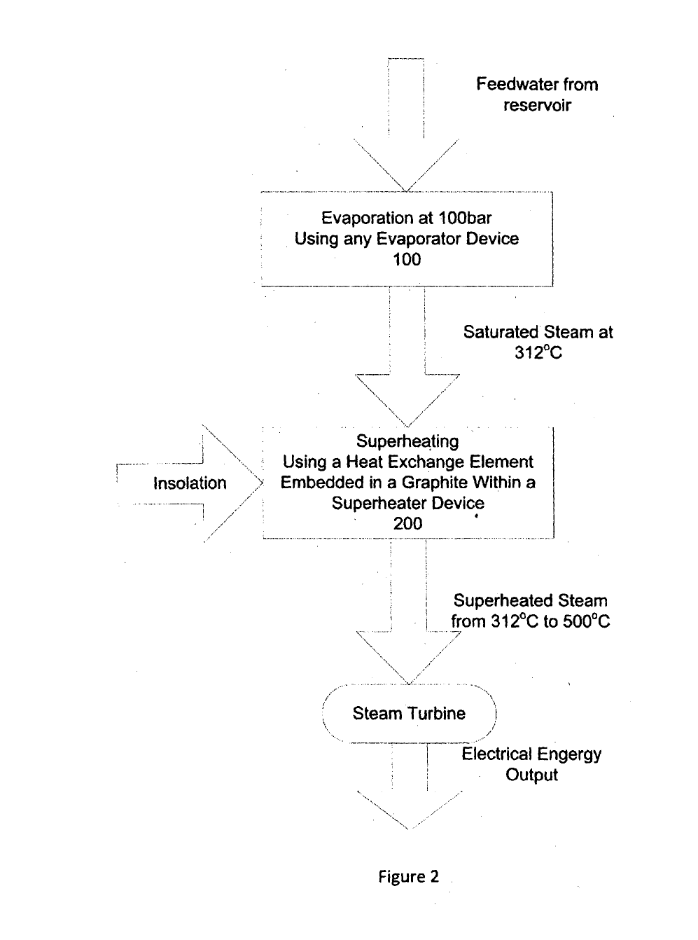

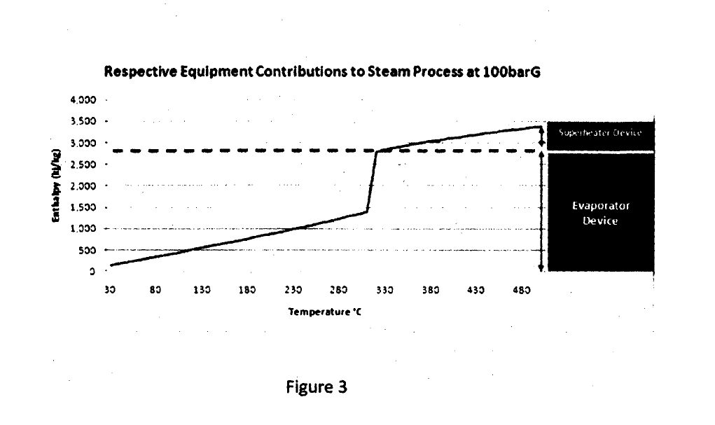

For simplicity the following description is provided using water/steam as the working fluid, however it will be appreciated that other working fluids such as super-critical CO₂ may also be used. Referring first to FIG. 2, the process (100) involves firstly receiving feed water from a reservoir 37 (see FIG. 1A) and heating it in a pressurized system (first heating apparatus 16) to raise its temperature. The output of this process is saturated steam, which for example at 100 barG may be heated up to 312° C.; as shown in FIG. 3, but may include pressures ranging from 1 barG to 250 barG.

With a solar powered Evaporator Device 16, the evaporation phase may be conducted by passing the water through a heat exchanger tube 24 (see FIG. 1B) which is heated by solar flux 39, for instance using a solar mirror 23 or heliostat that heats one side of the tube. During the evaporation phase the heat exchanger tube 24 remains filled with feed water. The high heat transfer rate between the heat exchanger tube 24 and water ensures an effective heat transfer relationship between the solar flux 39 on one side of the heat exchanger tube, and the feed water flowing within the heat exchanger tube.

The Evaporator Device 16 can be a linear heat exchanger tube 24 laterally arranged and heated by lateral solar reflectors 23, for instance a linear Fresnel or light-weight parabolic trough; or a nest of heat exchanger tubes on top of a tower heated by an array of solar reflectors or heliostats (not illustrated). It could also be a non-solar device such as conventional fossil-fueled boilers, waste heat recovery devices, geothermal or from other renewable or waste energy sources (examples of which are described with reference to FIGS. 1C & 1D).

During evaporation, the feed water changes phase into vapor, after which, it is then superheated to generate superheated steam by a Superheater Device 12. This change in state from liquid to vapor dramatically reduces the rate of heat transfer between the heat exchanger tubes and the steam within the heat exchanger tubes. When superheating is performed by insolation of the heat exchanger tubes directly, the risk of over temperature damage to the heat exchanger tubes significantly increases because of the drastically reduced heat transfer rate between the heat exchanger tube and the steam within the tube. When direct insolation of the heat exchanger tubes is not managed effectively during peak insolation periods, overheating of the heat exchanger tubes may result.

To overcome this problem, the heat exchanger tubes 32 of the Superheater Device 12 are embedded in graphite 31, so the solar flux 33 is decoupled from the heat exchanger tube by the graphite body 31. The heat transfer from graphite 31 to heat exchanger tube 32 is uniformly distributed across the whole circumference of the heat exchanger tube and is better matched to the heat transfer from the heat exchanger tube to the steam flowing within the heat exchanger tube 32. The level of solar energy concentrated on the graphite body, may be in the range of 20 to 2000 kW per tonne of graphite.

The embedded heat exchanger tube 32 is surrounded and in contact with the graphite 31. The specification of the graphite body 31 and the design of the interface with the heat exchanger tubes have tailored heat transfer characteristics which ensures a controlled flow of heat to the entire circumference of the heat exchanger tube. This intermediates the high heat flux from the solar mirror field 13 and manages any rapid and peaky variations in heat flux, for instance as a consequence of passing cloud cover.

The output of the Superheater Device 12 is generally fed to a steam turbine generator 11 to produce electrical energy or to an industrial steam application. A steam turbine generator driven with saturated steam typically only produces half the electrical output as a turbine driven with steam superheated beyond the point of saturation by a further 200° C. in temperature.

The temperature of the superheated steam may be in the range from saturation point (for example, 120° C. at 1 barG to 374° C. at 219 barG) to 700° C. In energy contribution terms, the feed water pre-heater/evaporation phase is contributing up to 85% of the enthalpy to the steam but the value of steam (due to lower steam turbine generator efficiency) at low temperature is much lower than superheated steam (due to the higher steam turbine generator efficiency). As a result of superheating steam, the value of the steam is doubled while providing only 15% of the enthalpy contribution.

Therefore the relationship of the energy contributions from the Superheater Device 12 when compared to the feed water pre-heater/evaporation phase (first heating apparatus 16) will range from 10% to 25%.

Steam turbine generator efficiency is not only affected by steam temperature. Steam pressure is also a significant factor, as well as the delivered range of steam temperature and pressure at the inlet. The narrower the range of steam temperature and pressure delivered to the steam turbine generator, the higher the steam turbine generator efficiency.

In the event of solar interruption, for instance due to incoming cloud cover or waning solar energy in late afternoon, the Evaporator Device 16 will not be able to maintain saturated steam output, but will deliver hot water. The Superheater Device 12 will draw from its thermal storage (graphite body 31) and as a result of the ratio of surface area of heat exchanger tube 32 to the graphite mass of the graphite body 31, will seamlessly transition to operate in a once-through boiler mode, which still produces superheated steam for the turbine 11 from hot water rather than saturated steam.

When the solar interruption passes, the Evaporator Device 16 will return from producing hot water to again producing saturated steam, and the Superheater Device 12 then transitions back from functioning as a once-through boiler to a superheater.

The Superheater Device 12 cycles its mode of operation between superheating, and evaporating/superheating. The in-built thermal storage of the superheater ensures it is able to maintain steam conditions to the steam turbine generator throughout the solar interruption within specified steam conditions.

The Superheater Device 12 is then designed to maintain the steam temperature and pressure to specified conditions to the inlet of the relevant steam turbine generator. This contrasts with direct steam CSP plants without thermal storage capacity, where the steam turbine generator will operate at reduced efficiency when insolation is interrupted and subsequently trip as steam conditions fall outside the specified temperature and pressure range, interrupting power generation. Typically the plant will need to go through a lengthy start-up procedure before recommencing electricity generation.

An additional process can begin after the Superheater Device 12 has exhausted sufficient thermal storage such that it can no longer maintain steam turbine quality superheated steam. Low flow low pressure steam can continue to be generated to maintain sufficient temperature in the CSP plant throughout the night to enable faster start-up the following morning and to prevent the system from drying up and taking in air which causes corrosion within the system. In this mode whilst there is not sufficient heat retained in the thermal storage to maintain superheated steam, there is enough stored heat to maintain low quality steam for this additional process.

Although the invention has been exemplified with reference to a particular embodiment, it should be appreciated that it may be embodied in many other forms and variants. For instance, the superheater device may receive saturated or low superheated steam directly or indirectly from the evaporation stage. For example, it may receive steam discharged from a steam turbine and reheat it to be fed back to the intermediate or low pressure stage of the steam turbine.

An embodiment of the invention has been described with reference to superheating steam to a level below the supercritical point, but can be applied to superheating steam that is under sufficient pressure so that when heated it becomes supercritical.

An embodiment of the invention has been described with reference to water/steam as the working fluid. This process can equally apply to the use of other fluids, for example carbon dioxide as the working fluid. In this case, the turbine generator would be powered by high temperature supercritical carbon dioxide heated as described above by the

Superheater Device 12. Carbon dioxide at a pressure of 6 barG becomes supercritical at a temperature of 31° C. As with steam turbine generators, supercritical carbon dioxide turbine generators become more efficient the higher the temperature and pressure, ideally greater than 500° C. and 200 barG, although others are designed to operate at lower temperatures and pressures.

An embodiment of the invention describes a method of integrating the Superheater Device 12 to an Evaporator Device 16 which is powered by a waste heat recovery process or geothermal resources. There are many examples of waste heat recovery steam generators that can produce low to medium temperature steam, steam just above the saturation point for the relevant pressure. With this form of saturated steam sourced from waste heat of another process, the Superheater Device can generate superheated steam and due to the storage capability of the graphite mass, provide this superheating capacity for much longer periods of the day than traditional CSP plants, and potentially for 24 hours per day.

This process is similar when the saturated steam source has a geothermal origin.

1. A process for operating a turbine driven from renewable or waste energy sources wherein a working fluid which drives the turbine is passed around a working fluid circuit and heated in a two stage heating process using a first heating apparatus using a renewable or waste energy source and a second heating apparatus comprising a graphite body heated by concentrated solar energy the graphite body containing an embedded heat exchanger comprising at least one heat exchanger tube embedded in and in contact with the graphite body, the process, comprising:
heating the working fluid using the renewable or waste source to generate a stream of working fluid heated to an intermediate temperature;
heating the graphite body using the concentrated solar energy to store heat within the graphite body;
delivering the stream of heated working fluid into the heat exchanger which is embedded in the graphite body whereby the graphite body releases stored heat to heat the working fluid to provide a continuous stream of the working fluid heated to a working temperature for input to the turbine; and
wherein, a relationship exists between an outer surface area of the embedded heat exchanger tube and a mass of graphite in the graphite body whereby there is from 0.60 m² to 20 m² of outer surface area of embedded heat exchanger tube per tonne of graphite in the graphite body.

2. The process of claim 1 wherein the relationship between the outer surface area of the embedded heat exchanger tube and the mass of graphite in the graphite body is in the range of 0.60 m² to 2.0 m², or 1.0 m² to 4.0 m², or 2.0 m² to 5.0 m², or 2.0 m² to 2.50 m², or 2.50 m² to 5.0 m², or 4.0 m² to 6.0 m², or 5.0 m² to 8.0 m², or 6.0 m² to 10.0 m², or 8.0 m² to 12.0 m², or 10.0 m² to 14.0 m² or 12.0 m² to 16.0 m², or 14.0 m² to 18.00 m², or 16.0 m² to 20.0 m² of outer surface area of embedded heat exchanger tube per tonne of graphite in the graphite body.

3. The process of claim 1 wherein the relationship between the outer surface area of the embedded heat exchanger tube and the mass of graphite in the graphite body is in the range of 0.60 m² to 2.2 m², or 1.0 m² to 4.0 m², or 1.0 m² to 5.0 m², or 2.0 m² to 5.0 m², or 1.5 m² to 2.5 m², or 1.2 m² to 3.0 m², or 1.2 m² to 2.20 m², or 2.0 m² to 2.50 m², or 2.50 m² to 5.0 m² of outer surface area of embedded heat exchanger tube per tonne of graphite in the graphite body.

4. The process of claim 1 wherein the graphite receiver is switchable between a superheating only mode and an evaporation and superheating mode and the relationship between the outer surface area of the embedded heat exchanger tube and the mass of graphite in the graphite body is in the range of 1.2 m² to 3.0 m²/tonne of graphite in the graphite body.

5. The process of claim 1 wherein the graphite receiver is used only in a superheating mode and the relationship between the outer surface area of the embedded heat exchanger tube and the mass of graphite in the graphite body is in the range of 0.6 m² to 2.2 m²/tonne of graphite in the graphite body.

6. The process as claimed in claim 1 wherein flow of the heat transfer medium through the embedded heat exchanger is controlled such that when the stream of working fluid is heated to a temperature less than the intermediate temperature by the first heating apparatus due to a period of inadequate supply of the renewable or waste energy source, flow of the working fluid through the graphite body is controlled whereby the continuous stream of the working fluid out of the heat exchanger embedded in the graphite body continues to be heated to the working temperature for input to the turbine.

7. The process according to claim 6, wherein the first heating apparatus is also heated by concentrated solar energy and the period of inadequate supply is a period of interruption to, or reduction-of, insolation to the first heating apparatus.

8. The process according to claim 6, wherein the first heating apparatus is heated using heat provided from a waste heat recovery origin and the period of inadequate supply is a period of interruption to, or reduction of, availability of heat from the waste heat recovery origin to the first heating apparatus.

9. The process according to claim 6, wherein the first heating apparatus is heated by heat provided from a geothermal origin and the period of inadequate supply is a period of interruption to, or reduction of, heat provided from a geothermal origin to the first heating apparatus.

10. The method as claimed in claim 1 wherein, solar concentrators are provided to heat the graphite body, the solar concentrators having a capacity to direct concentrated solar energy to the graphite body with a peak power in the range of 20 to 2000 kW per tonne of graphite in the graphite body at periods of peak insolation.

11. The method as claimed in claim 10 wherein, the solar concentrators are provided having a capacity to direct concentrated solar energy to the graphite body with a peak power per tonne of graphite in the range of 20 kW to 80 kW, or 50 kW to 100 kW, or 80 kW to 150 kW, or 100 kW to 200 kW, or 150 kW to 250 kW, or 200 kW to 300 kW, or 250 kW to 450 kW, or 300 kW to 500 kW, or 450 kW to 600 kW, or 500 kW to 800 kW, or 600 kW to 900 kW, or 800 kW to 1200 kW, or 900 kW to 1500 kW, or 1200 kW to 1800 kW, or 1500 kW S to 2000 kW, or per tonne of graphite in the graphite body.

12. The process according to claim 1, wherein during periods of peak insolation, when the concentrated solar energy being delivered to the graphite body is greater than a level of energy required to heat the working fluid to the working temperature, the graphite body absorbs and stores any additional energy for use later whereby energy dumping is minimized or eliminated and the graphite body regulates heat transfer to the heat exchanger tube to avoid overheating of the heat exchanger tube without regard to the level of insolation.

13. The process according to claim 1 wherein during an interruption to, or reduction of, insolation when the concentrated solar energy being delivered to the graphite body is less than a level of energy required to heat the working fluid to the working temperature, thermal energy stored in the graphite body, due to previous heating by the concentrated solar energy, is drawn on to sustain the heating of the working fluid to the working temperature.

14. The process according to claim 13, wherein after an interruption to, or reduction of insolation when the concentrated solar energy being delivered to the graphite body is less than a level of energy required to heat the working fluid to the working temperature for a period of time results in a reduction of the thermal energy stored in the graphite body to a level which ceases to be adequate for heating the working fluid to the working temperature, residual thermal energy in the graphite body is used to heat the working fluid to a maintenance temperature and the working fluid is circulated to maintain conditions within the working fluid circuit.

15. The process according to claim 6, wherein the working fluid is water/steam and the water/steam is under sufficient pressure so that when it is heated in the heat exchanger embedded in the graphite body it becomes supercritical.

16. The process according to claim 15 wherein the working fluid at the intermediate temperature from the first heating apparatus is saturated steam and when the working fluid is heated to a temperature less than the intermediate temperature it is hot water.

17. The process according to claim 1, wherein the working fluid is carbon dioxide which when at the working temperature is supercritical.

18.-44. (canceled)
